(19) United States
(12) Patent Application Publication
(10) Pub. No.: US 2024/0156094 A1
(43) Pub. Date: May 16, 2024

(54) MELATONIN COMPOSITION WITH METALS AND A METHOD FOR ENHANCING ENZYMATIC REACTIONS AND METABOLIC PATHWAYS IN PLANTS

(71) Applicant: FERTIS INDIA PVT. LTD., Hyderabad (IN)

(72) Inventors: Rahul Raju KANUMURU, Hyderabad (IN); George Kochumalayil SHAJI, Hyderabad (IN); Lakshmi Prasanna Kumar GARUDADRI, Hyderabad (IN); Ravikumar SURANENI, Hyderabad (IN); Sil ANINDYA, Hyderabad (IN)

(21) Appl. No.: 18/282,399

(22) PCT Filed: Mar. 19, 2022
(86) PCT No.: PCT/IN2022/050268

§ 371 Date: Sep. 15, 2023

(30) Foreign Application Priority Data
Mar. 20, 2021 (IN) 202141011969

(51) Int. Cl. A01N 43/38; A01N 25/30; A01P 21/00; C05D 1/00; C05D 5/00

(52) U.S. Cl. CPC A01N 43/38; A01N 25/30; A01P 21/00; C05D 1/00; C05D 5/00

(57) ABSTRACT

The present invention relates to an agricultural composition that comprises melatonin together with metal ion compounds or metal complexes that improve the catalytic activity of enzymes that are involved in metabolic pathways in the plant system, thus improving productivity and its quality. The present invention further relates to a method for enhancing enzymatic reactions and metabolic pathways in plants in the presence of the present composition. The present agricultural composition further aids in plant growth in terms of crop production, total phenol content, total protein content, plant height, leaf area, reduction in stress symptoms, and nutrient composition.

### TECHNICAL FIELD OF THE INVENTION

The present invention relates to an agricultural composition of Melatonin with metal ion compound(s) or a metal complex or metal oxide(s) for improving the catalytic activity of enzymes involved in metabolic pathways in plant systems to yield increased produce and enhanced quality.

### BACKGROUND AND PRIOR ART OF THE INVENTION

Melatonin is classified as a potent, naturally occurring antioxidant and a signaling molecule based on its primary and secondarily-evolved functions in organisms. Melatonin is classified as a potent, naturally occurring antioxidant and a signaling molecule based on its primary and secondarily-evolved functions in organism

Melatonin (N-Acetyl-5-methoxytryptamine) is an indole-based structure which is classified as a potent, naturally occurring antioxidant and a signalling molecule based on its primary and secondarily-evolved functions in organisms. Melatonin plays an important role as a potential modulator on plant growth and development. Evidence has confirmed that a major portion of the melatonin is synthesized by plants themselves even though a homologue of the classic aryl alkyl amine N-acetyltransferase (AANAT) has not been identified as yet in plants.

Research shows that melatonin plays critical roles in plant defence systems. Almost all the abiotic stresses which cause oxidative stress can be alleviated by melatonin treatment if the concentration of melatonin is appropriate. Researchers have demonstrated possible mechanisms of this protective effect against internal and environmental oxidative stress. Researches also show that the physiological role of melatonin in plants also involves the regulation of their response to photoperiod, fruit development, delayed flowering, and leaf senescence. Melatonin also acts as a growth regulator, similar to indole acetic acid (IAA), and may direct the differentiation of cells, tissues, and organs. Previous studies have shown that the application of exogenous melatonin in plants promotes lateral root regeneration, growth and metabolism.

Marino B. Arnao et al. in a research study published in Plant Signaling & Behavior, 2007 titled “Melatonin in Plants” discloses that an exogenous application of melatonin helps in promoting lateral root regeneration, and growth in plants.

Janas, K. M et al. in a research study published in Acta Physiologiae Plantarum, 2013 titled “Melatonin, an underestimated natural substance with great potential for agricultural application” discloses that an exogenous application of melatonin helps in improving stresses tolerance in plants.

Jiang-Fei Meng et al. in a research study published in Food Science and Technology, 2019 titled “Melatonin treatment of pre-veraison grape berries modifies phenolic components and antioxidant activity of grapes and wine” discloses that an exogenous application of melatonin helps in improving the concentration of cyanin-3-O-glucoside, peonidin derivatives, and flavanols in grapes.

PCT Publication No. WO2017062856 discloses an invention for managing ethylene in plants using a synergistic agricultural formula comprising diacyl or diary urea and at least one metal complex. However, prior art literature is silent on any attempts to enhance melatonin levels in plants to obtain efficient growth and quality of produce.

Based on the literature pertaining to melatonin applications, there is a need in the art to provide a cost-effective and efficacious melatonin composition that helps in enhancing crop yield and crop quality so as to benefit human nutrition.

### Object of Invention

Accordingly, the main objective of the present invention is to provide an agricultural composition that comprises melatonin together with metal ion compound(s), metal complex or metal oxide(s) that improve the catalytic activity of enzymes that are involved in metabolic pathways in the plant system, thus improving productivity and its quality.

Another object of the present invention is to provide a method for enhancing enzymatic reactions and metabolic pathways in plants in the presence of present agricultural composition.

### SUMMARY OF THE INVENTION

Accordingly, the present invention discloses an agricultural composition that comprises melatonin together with metal ion compound(s) or metal complex that improve the catalytic activity of enzymes that are involved in metabolic pathways in the plant system, thus improving productivity and its quality.

In an embodiment of the present invention, the agricultural composition comprises melatonin in a concentration ranging from 0.1 to 20 wt % and at least one metal ion compound or a metal complex in a concentration ranging from 0.1 to 20 wt %, wherein, the composition further optionally comprises nitrogenous compounds with minerals.

In another embodiment of the present invention, metal in the melatonin-metal complex of the agricultural composition is selected from a group comprising calcium, potassium, copper, cobalt, zinc, iron, boron, manganese, magnesium, nickel, selenium, molybdenum, and iodine.

In still another embodiment of the present invention, the metal ion of the agricultural composition is selected from a group comprising Cu²⁺, Zn²⁺, Co²⁺, Ni²⁺, Mn²⁺, Mo²⁺, Fe^{3+/2+}, and Se⁴⁺.

In yet another embodiment of the present invention, the agricultural composition further comprise excipients, such as adjuvants, wetting agents, and surfactants selected from anionic, non-ionic, and cationic surfactants, such as lignosulfonates, etc., that ensure uniform and wide spreading of the composition on foliage when applied to maintain leaf and molecule contact.

In still another embodiment of the present invention, the agricultural composition can be applied to the plants in the form of powder, liquid, sprays, gel, or injection in an appropriate amount.

In another embodiment of the present invention, a method for enhancing enzymatic reactions and metabolic pathways involved in the production of melatonin in plants using the present agricultural composition is further disclosed.

In a preferred embodiment of the present invention, a method for enhancing enzymatic reactions and metabolic pathways involved in the production of melatonin in plants by using the present agricultural composition is further disclosed.

### BRIEF DESCRIPTION OF THE DRAWINGS

The invention has other advantages and features which will be more readily apparent from the following detailed description of the invention and the appended claims, when taken in conjunction with the accompanying drawings, in which:

FIG. 1: depicts the enhanced melatonin activity of the agricultural composition in the presence of micronutrients in different plant species.

FIG. 2: depicts the synergy of the agricultural composition with respect to phenolic content over melatonin applied alone compared with farmer practice.

FIG. 3: depicts the synergy of the agricultural composition with respect to protein content over melatonin applied alone compared with farmer practice.

### DETAILED DESCRIPTION OF THE INVENTION

While the invention has been disclosed with reference to certain embodiments, it will be understood by those skilled in the art that various changes may be made and equivalents may be substituted without departing from the scope of the invention. In addition, many modifications may be made to adapt to a particular situation or material to the teachings of the invention without departing from its scope.

Throughout the specification and claims, the following terms take the meanings explicitly associated herein unless the context clearly dictates otherwise. The meaning of “a”, “an”, and “the” include plural references. The meaning of “in” includes “in” and “on.” Referring to the drawings, like numbers indicate parts throughout the views. Additionally, a reference to the singular includes a reference to the plural unless otherwise stated or inconsistent with the disclosure herein.

The tables, figures and protocols have been represented where appropriate by conventional representations in the drawings, showing only those specific details that are pertinent to understanding the embodiments of the present invention so as not to obscure the disclosure with details that will be readily apparent to those of ordinary skill in the art having benefit of the description herein.

Accordingly, to accomplish the objectives of the present invention, the inventors propose an agricultural composition that comprises melatonin together with metal ion compounds or metal complexes that improve the catalytic activity of enzymes that are involved in metabolic pathways in the plant system, thus improving productivity and its quality.

In an embodiment of the present invention, the agricultural composition comprises melatonin in a concentration ranging from 0.1 to 20 wt % and at least one metal ion compound or a metal complex in a concentration ranging from 0.1 to 20 wt %, wherein, the composition further optionally comprises nitrogenous compounds with minerals.

In a preferred embodiment, the agricultural composition comprises melatonin in a concentration ranging from 2 g/acre to 10 g/acre.

In another embodiment of the present invention, metal in the melatonin-metal complex of the agricultural composition is selected from a group comprising calcium, potassium, copper, cobalt, zinc, iron, boron, manganese, magnesium, nickel, selenium, molybdenum, and iodine.

In still another embodiment of the present invention, the metal ion of the agricultural composition is selected from a group comprising Cu²⁺, Zn²⁺, Co²⁺, Ni²⁺, Mn²⁺, Mo²⁺, Fe^{3+/2+}, and Se⁴⁺. The formulation could be made from at least one of the above metal ions or in combination thereof.

In yet another embodiment of the present invention, the agricultural composition comprising the melatonin together with a metal ion(s) or metal ion complex is in a ratio ranging from 0.1:10 to 1:10.

In another embodiment of the present invention, the agricultural composition further comprises minerals and trace metals in a concentration ranging from 400 g/acre to 1000 g/acre.

In still another embodiment of the present invention, the agricultural composition also contains iodine in a ratio ranging from 0.05 to 0.1.

In yet another embodiment of the present invention, the agricultural composition further comprises excipients, such as adjuvants, wetting agents, and surfactants selected from anionic, non-ionic, and cationic surfactants, such as CMC, lignosulfonates, etc., that ensure uniform and wide spreading of the composition on foliage when applied to maintain leaf and molecule contact.

In still another embodiment of the present invention, the agricultural composition contains an additional active ingredient including primary nutrients such as Nitrogen, Phosphorous, and Potash as well as secondary nutrients such as calcium, magnesium, sulfur compounds, etc., all of which include silica.

In yet another embodiment of the present invention, the agricultural composition optionally comprises hormones auxin, cytokinin, gibberellic acid, brassinosteroids, ethylene, abscisic acid, salicylic acid and Jasmonic acid etc either individually or in combination, wherein the concentrations of the hormones are in the range of 0.05% to 10%.

In still another embodiment of the present invention, the agricultural composition may comprise additional nutritional products and/or growth stimulation agents, such as amino acid powders, essential oils, and excipients like emulsifiers, thickeners, suspension agents, and wetting agents.

In another embodiment of the present invention, the agricultural composition can be applied to the plants in the form of powder, liquid, sprays, gel, or injection in an appropriate amount.

In still another embodiment of the present invention, the agricultural composition can be applied to the plant foliage at a concentration ranging from 0.1 to 10 g/L.

In yet another embodiment of the present invention, micronutrients in the agricultural composition aid in the transport of ions to grains, tubers, fruits, and vegetables of a plant.

In still another embodiment of the present invention, the agricultural composition aids in plant growth in terms of crop production, total phenol content, total protein content, plant height, leaf area, reduction in stress symptoms, and nutrient composition.

In a preferred embodiment of the present invention, a method for enhancing enzymatic reactions and metabolic pathways involved in the production of melatonin in plants by using the present agricultural composition is further disclosed.

### EXAMPLES

The following examples, which include preferred embodiments, will serve to illustrate the practice of this invention, it being understood that the particulars shown are by way of example and for the purpose of illustrative discussion of preferred embodiments of the invention.

### Example 1:—Composition Preparation

### Composition Consisting of Melatonin and Metal Ions (Different Micro-Nutrients)

### General Procedure for Formulation of Said Composition:

Components mentioned in table 1 were blended in a clean ss vessel and rotated at low rpm with 50 rpm to make a homogeneous mixture. The above mixture was used as a foliar product for agriculture applications.

TABLE 1

| | | g in Qty/ | g in Qty/ | g in Qty/ |
|---|---|---|---|---|
| S No | Component name | acre | acre | acre |
| 1 | Melatonin | 1.125 | 2.25 | 4.5 |
| 2 | Calcium Formate and Boric acid | 125 | 250 | 500 |
| 3 | Copper sulphate pentahydrate | 1.125 | 2.25 | 4.5 |
| 4 | Zinc Sulphate monohydrate | 50 | 100 | 200 |
| 5 | Ferrous sulphate Heptahydrate | 50 | 100 | 200 |
| 6 | Manganese sulphate Monohydrate | 50 | 100 | 200 |
| 7 | Magnesium sulphate Anhydrous | 25 | 50 | 100 |
| 8 | Nickel Sulphate Hexahydrate | 10 | 20 | 40 |
| 9 | Cobalt sulphate Heptahydrate | 10 | 20 | 40 |
| 10 | Potassium Iodide | 1.5 | 3 | 6 |
| 11 | Adjuvants | 3.5 | 7 | 14 |
| 12 | Soluble fillers | 72.75 | 46 | 91 |
| | Total weight in g/acre | 400 | 700 | 1400 |

### Example 2: Composition Consisting of Melatonin and Metal Ions Along with Hormones

TABLE 2

| | | g in Qty/ | g in Qty/ | g in Qty/ |
|---|---|---|---|---|
| S No | Component name | acre | acre | acre |
| 1 | Melatonin | 1.125 | 2.25 | 4.5 |
| 2 | Calcium Formate and Boric acid | 125 | 250 | 500 |
| 3 | Copper sulphate pentahydrate | 1.125 | 2.25 | 4.5 |
| 4 | Zinc Sulphate monohydrate | 50 | 100 | 200 |
| 5 | Ferrous sulphate Heptahydrate | 50 | 100 | 200 |
| 6 | Manganese sulphate Monohydrate | 50 | 100 | 200 |
| 7 | Magnesium sulphate Anhydrous | 25 | 50 | 100 |
| 8 | Nickel Sulphate Hexahydrate | 10 | 20 | 40 |
| 9 | Cobalt sulphate Heptahydrate | 10 | 20 | 40 |
| 10 | Potassium Iodide | 1.5 | 3 | 6 |
| 11 | Gibberellic acid | 1 | 2 | 4 |
| 12 | Abscisic acid | 0.5 | 1 | 2 |
| 13 | Adjuvants | 5 | 10 | 20 |
| 14 | Filler | 70 | 140 | 280 |
| | Total weight in gm | 400 | 800 | 1600 |

### Example 3: Analysis of Micronutrient Absorption Levels in Paddy Grains

### Analysis of Micronutrients in Paddy Samples by ICP (Inductive Coupled Plasma) Equipment.

The method include the steps of:—
1. 1 gm of grain powder was added to 60 ml of perchloric acid and Nitric acid (9:1) and were digested overnight.
2. Heat the mixtures at 100 c for 2 hours until vapors change from red to white color.
3. The resultant solution was filtered through a Whatman paper and makeup to 100 ml with 1% nitric acid.
4. The solution was tested for micronutrients by ICP.

### Result:

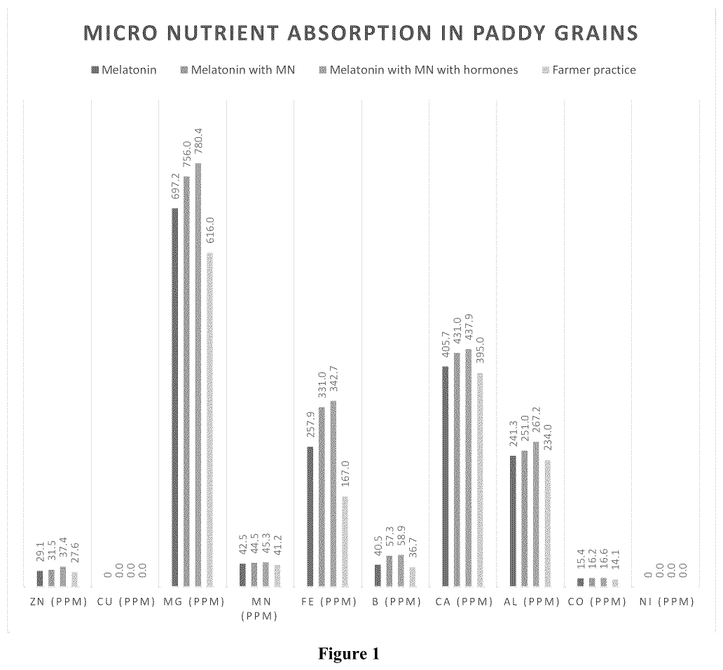

The amount of micronutrients present in the given paddy samples were found to be in a concentration ranging from 10-25 PPM disclosed in Table 3 and further depicted in FIG. 1.

TABLE 3

| | Zn | Cu | Mg | Mn | Fe | B | Ca | Al | Co | Ni |
|---|---|---|---|---|---|---|---|---|---|---|
| Sample name | (ppm) | (ppm) | (ppm) | (ppm) | (ppm) | (ppm) | (ppm) | (ppm) | (ppm) | (ppm) |
| Farmer practice | 27.6 | ND | 616.0 | 41.2 | 167.0 | 36.7 | 395.0 | 234.0 | 14.1 | ND |
| Melatonin | 29.1 | ND | 697.2 | 42.5 | 257.9 | 40.5 | 405.7 | 241.3 | 15.4 | ND |
| Melatonin with MN | 31.5 | ND | 756.0 | 44.5 | 331.0 | 57.3 | 431.0 | 251.0 | 16.2 | ND |
| Melatonin with MN | 37.4 | ND | 780.4 | 45.3 | 342.7 | 58.9 | 437.9 | 267.2 | 16.6 | ND |
| with hormones | | | | | | | | | | |

### Example 4: Analysis of Phenolic Content Over Melatonin Applied Alone Compare with Farmer Practice

Total polyphenol content were estimated by performing the following steps:—
10-15 ml of 70% MeOH (70 ml methanol: 30 ml water) were added to 1 g of test sample
Filter through whatman filter paper 1 and was made up to 25 ml with 70% methanol.
5 ml of folin ciocalteu's phenol reagent were added.
Incubation for 5 mins.
4 ml of 7.5% Na2CO3 were added and incubated for 1 hr.
absorbance was measured at 765 nm.

### Result:

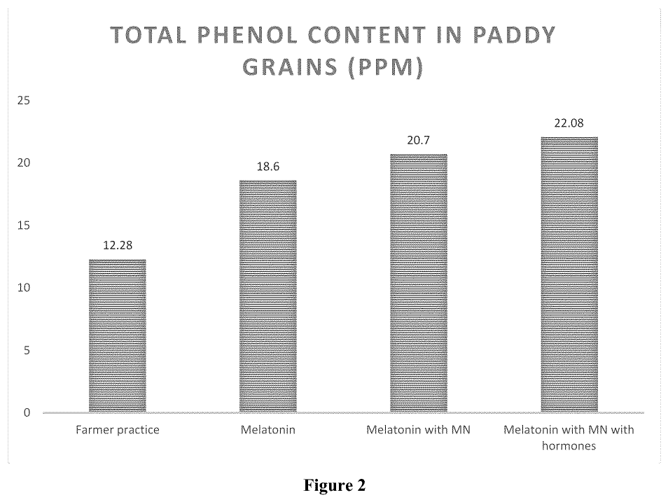

The amount of total polyphenol present in the given sample was found to be in a concentration ranging from 10-25 ppm disclosed in Table 4 and further depicted in FIG. 2.

TABLE 4

| | | Total Phenol |
|---|---|---|
| S. NO | Sample name | content in ppm |
| 1 | Farmer practice | 12.28 |
| 2 | Melatonin | 18.6 |
| 3 | Melatonin with MN | 20.7 |
| 4 | Melatonin with MN with | 22.08 |
| | hormones | |

Note:
MN as micronutrients

### Example 5: Analysis of Protein Content Over Melatonin Applied Alone Compare with Farmer Practice

Total protein content in the sample content were estimated by performing Lowry method which include the following steps:—
1 g of samples in 25 ml were filtered through whatman filter paper 1
4.5 ml of a reagent comprising NaOH, sodium potassium tartrate, and CuSO4.5H2O were added and incubated for 10 mins.
After incubation, 0.5 ml of Folin-Ciocalteu's phenol reagent were added and incubated for 30 mins.
Absorbance was measured with UV Vis Spectrophotometer At 660 nm and a standard graph was plotted.

### Result:

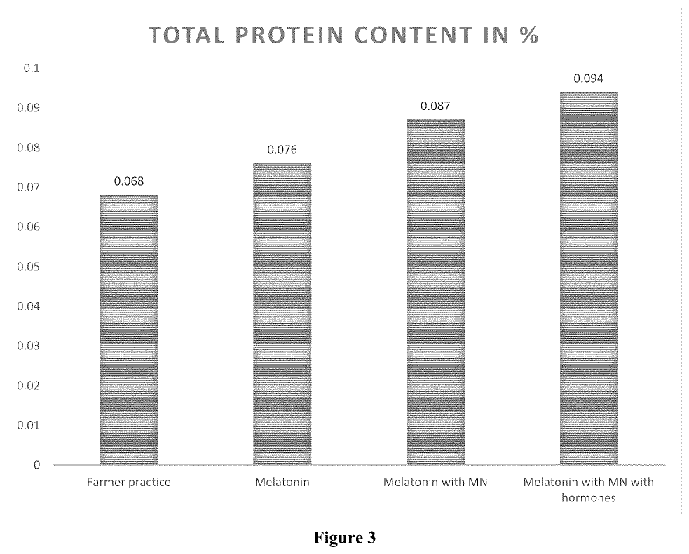

The amount of protein present in the given sample was found to be in a concentration ranging from 0.001-0.01%, further depicted in Table 5 and FIG. 3.

TABLE 5

| | | Total Protein |
|---|---|---|
| S. NO | Sample name | content in % |
| 1 | Farmer practice | 0.068 |
| 2 | Melatonin | 0.076 |
| 3 | Melatonin with MN | 0.087 |
| 4 | Melatonin with MN | 0.094 |
| | with hormones | |

### Advantages of the Invention

1. A cost-effective and efficacious melatonin composition that helps in enhancing crop yield and crop quality further benefit human nutrition
2. Helps transport ions to grains, tubers, fruits, and vegetables of a plant
3. Contributes to crop production, total phenol content, total protein content, plant height, leaf area, reduction of stress symptoms, and nutrient composition
4. Activates enzymes and metabolic pathways involved in the production of melatonin in plants

We claim:

1. An agricultural composition comprising melatonin in a range of about 0.1% to 20% (wt); and at least one metal compound in the form of metal ion or metal complex in a range of about 0.1% to 20% (wt); wherein the melatonin and the metal in the composition is in a ratio ranging from 0.1:10 to 1:10.

2. The agricultural composition as claimed in claim 1, wherein the metal in the metal complex is selected from a group comprising calcium, potassium, copper, cobalt, zinc, iron, boron, manganese, magnesium, nickel, selenium, molybdenum, and iodine.

3. The agricultural composition as claimed in claim 1, wherein the metal ion is selected from a group comprising Cu²⁺, Zn²⁺, Co²⁺, Ni²⁺, Mn²⁺, Mo²⁺, Fe^{3+/2+}, and Se⁴⁺.

4. The agricultural composition as claimed in claim 1, wherein the composition further comprises iodine, hormones, excipients, surfactants, additional active ingredients, additional nutritional products, growth stimulation agents, nitrogenous compounds with minerals, and minerals and trace metals.

5. The agricultural composition as claimed in claim 4, wherein the iodine is in a ratio ranging from 0.05 to 0.1.

6. The agricultural composition as claimed in claim 4, wherein the hormones are auxin, cytokinin, gibberellic acid, brassinosteroids, ethylene, abscisic acid, salicylic acid and Jasmonic acid present either individually or in combination.

7. The agricultural composition as claimed in claim 6, wherein the hormones are in a concentration ranging from 0.05% to 10%.

8. The agricultural composition as claimed in claim 4, wherein the excipients are selected from adjuvants, emulsifiers, thickeners, suspension agents, and wetting agents.

9. The agricultural composition as claimed in claim 8, wherein the excipients are in a concentration ranging from 0.1 to 5%.

10. The agricultural composition as claimed in claim 4, wherein the surfactants are selected from anionic, non-ionic, and cationic surfactants.

11. The agricultural composition as claimed in claim 10, wherein the surfactants are in a concentration ranging from 0.1 to 10%.

12. The agricultural composition as claimed in claim 4, wherein the additional active ingredients are selected from primary nutrients and secondary nutrients.

13. The agricultural composition as claimed in claim 12, wherein the primary nutrients are selected from Nitrogen, Phosphorous, and Potash.

14. The agricultural composition as claimed in claim 12, wherein the secondary nutrients are selected from Calcium, Magnesium, and Sulfur compounds.

15. The agricultural composition as claimed in claim 12, wherein the additional active ingredients are in a concentration ranging from 0.1 to 10%.

16. The agricultural composition as claimed in claim 4, wherein the additional nutritional products and/or growth stimulation agents are selected from amino acid powders, and essential oils.

17. The agricultural composition as claimed in claim 16, wherein the additional nutritional products are in a concentration ranging from 0.1 to 5%.

18. The agricultural composition as claimed in claim 4, wherein the minerals and trace metals are in the range of about 400 g/acre to 1000 g/acre

19. The agricultural composition as claimed in claim 1, wherein the agricultural composition is in a concentration ranging from 2 g/acre to 10 g/acre.

20. The agricultural composition as claimed in claim 1, wherein the agricultural composition can be applied to the plants in the form of powder, liquid, sprays, gel, or injection in an appropriate amount.

21. The agricultural composition as claimed in claim 1, wherein the agricultural composition can be applied to the plant foliage at a concentration ranging from 0.1 to 10 g/L.
